(19) United States
(12) Patent Application Publication
(10) Pub. No.: US 2014/0044847 A1
(43) Pub. Date: Feb. 13, 2014

(54) Reusable Frothing Device

(71) Applicant: Franz Hellmaier, Salzburg (AT)

(72) Inventor: Franz Hellmaier, Salzburg (AT)

(21) Appl. No.: 14/000,026

(22) PCT Filed: Feb. 25, 2011
(86) PCT No.: PCT/EP2011/052803

§ 371 Date: Oct. 28, 2013

(51) Int. Cl. A47J 31/44

(52) U.S. Cl. CPC A47J 31/4485
USPC 426/474; 99/323.1

(57) ABSTRACT

The present invention relates to a reusable frothing device (100) for the use in a device for making beverages, in particular for frothing milk in coffee makers. The frothing device comprises at least one first body (101) and a second body (103), which comprise recesses, which form in the assembled state complete channels. For the assembly, the bodies (101, 103) are provided with appropriate coupling members (125, 126, 127), which allow a repeated assembling and disassembling of the bodies (101, 103) so that the recesses in the bodies are laid open in the disassembled state for the sake of cleaning.

### 1. FIELD OF THE INVENTION

The invention relates to a reusable frothing device for the use in a device for making beverages, like for instance in a cappuccino machine or in a machine for making frothed milk.

### 2. TECHNICAL BACKGROUND

It is known to provide means for frothing hot milk in machines for making hot beverages, like for instance in modern coffee machines, in order to mix the frothed hot milk for the finishing of the hot beverage like for instance with coffee. For the generation of the milk froth, commonly the Venturi-principle is used. Herein, hot water vapor is led under-pressure through a first pipe, which is connected to a further pipe. By the hot water vapor flow in the first pipe, an under-pressure is generated in the further pipe. When this further pipe is now connected to a milk container, milk is sucked in by the water vapor flow and is also sucked into the first pipe. Commonly, the first pipe leads to an expansion chamber in which milk froth is generated from the milk by the sudden expansion and the impact of the hot water vapor.

Document U.S. Pat. No. 4,715,274 discloses an example for a corresponding Venturi-arrangement for generating milk froth. It is described herein, to lead vapor under-pressure in a pipe by which the hot vapor flows in tangential direction in a cylindrical expansion chamber. This pipe is similar to the above mentioned one: a milk pipe is connected in that milk is sucked in by the vapor flow and the Venturi-effect and in that the milk can flow together with the hot vapor into the cylindrical expansion chamber. This milk-steam mixture is further mixed by circulation in the cylindrical chamber, wherein the generation of milk froth is further supported. At a port of the expansion chamber, which is provided therefore, the finished milk froth exits for the further use.

A further development of this kind of devices for the generation of milk froth is disclosed in document EP 0 813 834 A1. Similar to the above described example, also herein a flow of hot vapor is used in order to generate by the Venturi-effect an under-pressure in a connected further pipe by which milk is sucked in. By the mixing of hot vapor with milk and the subsequent expansion, milk froth is generated from the milk, which may be for instance used for the preparation of cappuccino.

A disadvantage of such conventional devices for the generation of milk froth is the often relatively difficult cleaning of the devices. The cleaning of pipes or flexible tubes, which are necessary for the supply of beverage liquids in particular of milk to the Venturi-device, is often difficult and only possible in an incomplete manner. In particular when milk is used, solid residues may appear, which may lead to hygiene problems if they stay for a longer period of time in the pipes or flexible tubes due to the difficult cleaning. An option to circumvent this disadvantage is the use of one-way-cartridges, which already contain the necessary beverage ingredients and which may be used for one time or possibly also for limited several times in a beverage machine so that supply pipes or flexible supply tubes are not necessary. After the use, such one-way-cartridges are simply disposed and a cleaning is not necessary.

A-one-way-cartridge of the above mentioned kind is for example disclosed in document US 2008/0250937 A1. This one-way-cartridge comprises a reservoir for instance for coffee, a reservoir for instance for milk and a channel system for the guiding of the beverage liquids. A corresponding channel is connected to each of the reservoirs, wherein the channel is also connected to a channel for the supply of steam from outside. According to the U.S.' 937, both, the reservoirs and the channels may be realized in the form of cavities in a base body, which is sealed by a film.

The cartridge is inserted into a beverage machine for the use, wherein the channels to the vapor pipe are connected to corresponding vapor supply pipes of the machine. During the use, vapor is led by the beverage machine into the channel system of the one-way-cartridge in that an under-pressure is generated in the channels, which are connected to the reservoirs, wherein the under-pressure sucks the beverage liquids into the channel system. Thus, if milk is stored in one of the reservoirs, milk froth may be generated by the mixing of milk and vapor, similar to the above described approaches. This milk froth may be led outside after its generation together with the beverage liquid of the other reservoir of the cartridge and thus can be mixed with it.

The one-way-cartridge has to be disposed after a one-time- or after a limited several-times-use, i.e. after some few uses, and has to be replaced by a new one-way-cartridge. Although the above described hygiene problems may be avoided by the provision of this one-way-cartridge, it is herein unsatisfactory that one-way-cartridges are used. The solution of the U.S.' 937 generates waste, which is on the one hand side disadvantageous for the environment and which is on the other hand side not appreciated by many customers.

Thus, it is a problem of the present invention to provide an improved frothing device, for instance for the generation of milk froth for hot beverages like for instance coffee, wherein the above described hygiene problems are avoided and less waste is generated.

### 3. SUMMARY OF THE INVENTION

The above mentioned problems are solved by a reusable frothing device according to main claim 1. Preferred further developments are described in the sub-claims and the further independent claims, respectively.

In order to solve the above mentioned problems, the present invention provides a reusable frothing device, which may be used for instance in a device for making beverages, like for instance a coffee dispenser. The frothing device is designed in that it may be disassembled in at least two bodies, which may be again connected by means of coupling members and may be separated again from each other. The term “repeatedly useable” means herein for instance a daily cleaning and a period of use of at least several months, preferably several years. At least one of the bodies comprises at its surface cavities, which are accessible in the disassembled state for the sake of cleaning.

Therefore, the reusable frothing device comprises at least a first body and a second body from which the reusable frothing device may be assembled and into which the reusable frothing device may be disassembled again. In other words, the bodies may be connected to a reusable frothing device and may be separated again from this connected state.

Herein, at least one of the two bodies comprises at its surface cavities, which form with a further surface of the other body in the assembled state of the reusable frothing device, complete channels. In a preferred embodiment, the other body preferably comprises complimentary cavities so that the cavities of the one body form together with the cavities of the other body in the connected state complete channels. The channels, which are formed from these cavities, are able to lead liquid, in particular milk or coffee, and are preferably arranged in one (single) sectional plane of the reusable frothing device. Due to the fact that the cavities are arranged in one sectional plane, a particularly simple and effective cleaning is possible.

Contrary to the above mentioned solutions of the prior art, it is possible by the design of the reusable frothing device according to the invention, to disassemble it after the use into the bodies, wherein the cavities, in which the liquids like for instance the milk are led, are freely accessible then and may be cleaned easily. Preferably, the bodies are made of dish washer-safe material like for instance of ceramics, porcelain or glass. But most preferred, the bodies are made of a (preferably injection-molding-manufactured) polymer. Preferably, none of the bodies is realized in the form of a film, since films are commonly not suitable for a many-fold, repeated cleaning. Contrary to such films, it is a core aspect of the present invention, that the bodies according to the invention may be repeatedly connected and separated again.

Thus it is possible to assemble and to disassemble the reusable frothing device repeatedly, wherein coupling members are assigned to the bodies, which allow a repeated connecting and separating of the bodies. Such coupling members may be for instance protrusions and complementary recesses; dovetail connections, tongue-and-groove-connections but also snap-lock-systems.

In a preferred embodiment, at least one of the bodies is provided with sealing members, in order to seal the assembled bodies in view of a leakage of liquid. Such sealing members may be provided for instance in the form of sealing rubbers, which have been inserted into corresponding recesses in the surface of the body or which are directly extruded onto the body. Alternatively, the bodies may be itself made of suitable materials, which are self-sealing due to its material properties. Conceivable are for instance appropriate soft polymers.

For the use, the reusable frothing device is inserted for instance into a device for making beverages, like for instance into a coffee maker. Alternatively, the frothing device may form a separate beverage machine. In a preferred embodiment, the reusable frothing device does not comprise a filled reservoir, which is already filled with a liquid prior to the connection. This constitutes a significant difference to the above mentioned one-way-cartridges, which comprise already filled reservoirs like for instance for milk or coffee. The liquids, like for instance milk or coffee are provided from outside, like for instance by the coffee maker, and are led through the reusable frothing device for the making of the hot beverage.

The reusable frothing device is suitable to be connected with a further supply device by which liquid may be led into the entry openings of the channels. Such a supply device may be for instance a flexible tube or pipe, which is for instance connected with a milk container. But it is difficult to clean flexible tubes or pipes completely from dirt, in particular from milk residues. In order to overcome this problem, the present invention provides a corresponding supply device.

This supply device also realizes the inventive idea, which constitutes the base of the reusable frothing device. Correspondingly, the supply device comprises at least a first supply body and a second supply body, wherein one of the two supply bodies comprises at a surface at least one cavity, which forms together with a further surface of the other supply body in an assembled state of the supply device at least one complete channel, which is appropriate to lead liquid, in particular milk or also coffee.

Accordingly, the present invention provides a system comprising a reusable frothing device and a supply device, which both provide the advantages according to the invention. Finally the present invention provides a machine for making beverages, like for instance a coffee maker, which comprises the reusable frothing device.

### 4. DESCRIPTION OF THE PREFERRED EMBODIMENTS

In the following, the invention will be described with reference to the accompanying figures. Herein shows:

FIG. 1 a schematic view of a first body;

FIG. 2 an alternative embodiment of a first body;

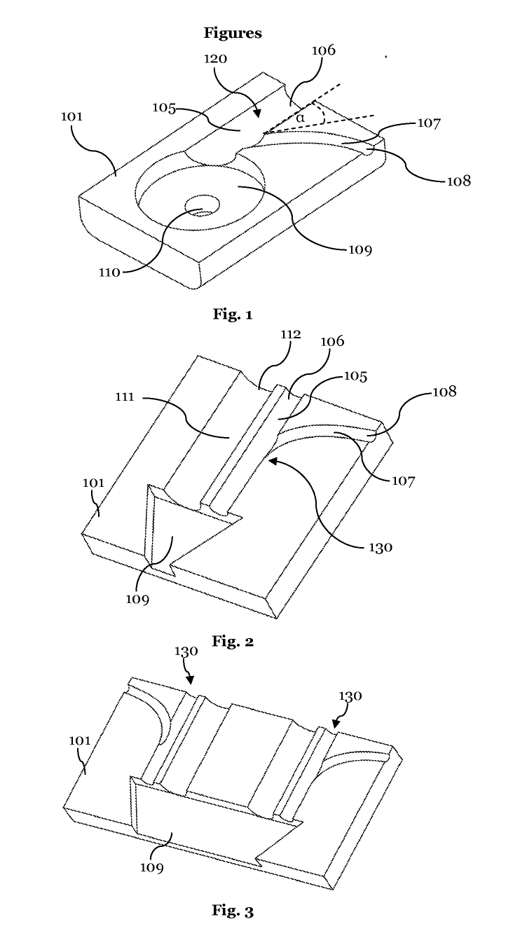

FIG. 3 still a further embodiment of a first body;

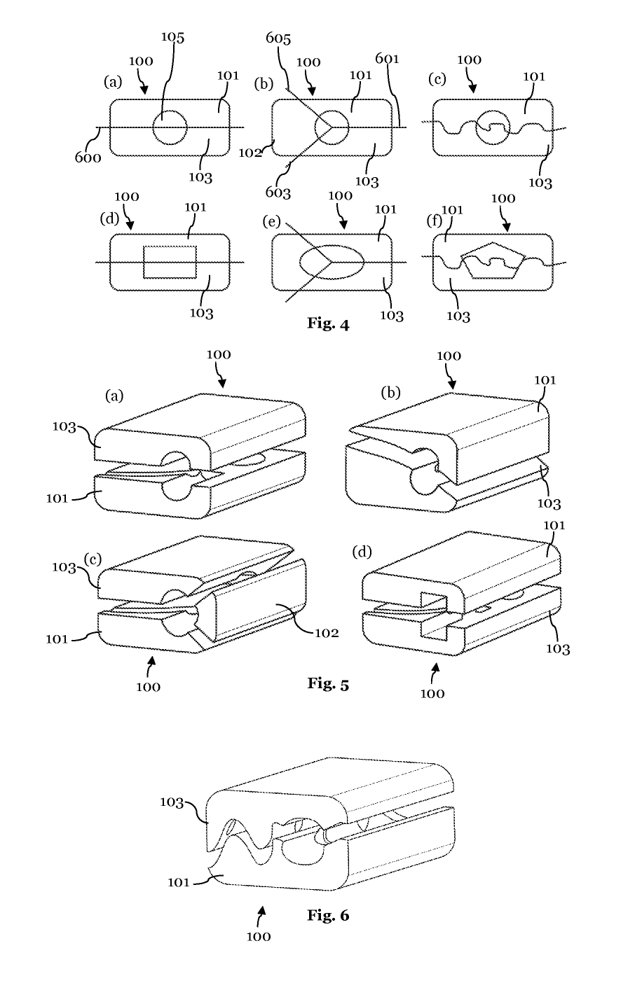

FIG. 4 schematic cross-sections of reusable frothing devices;

FIG. 5 schematic views of reusable frothing devices;

FIG. 6 a schematic view of a further reusable frothing device;

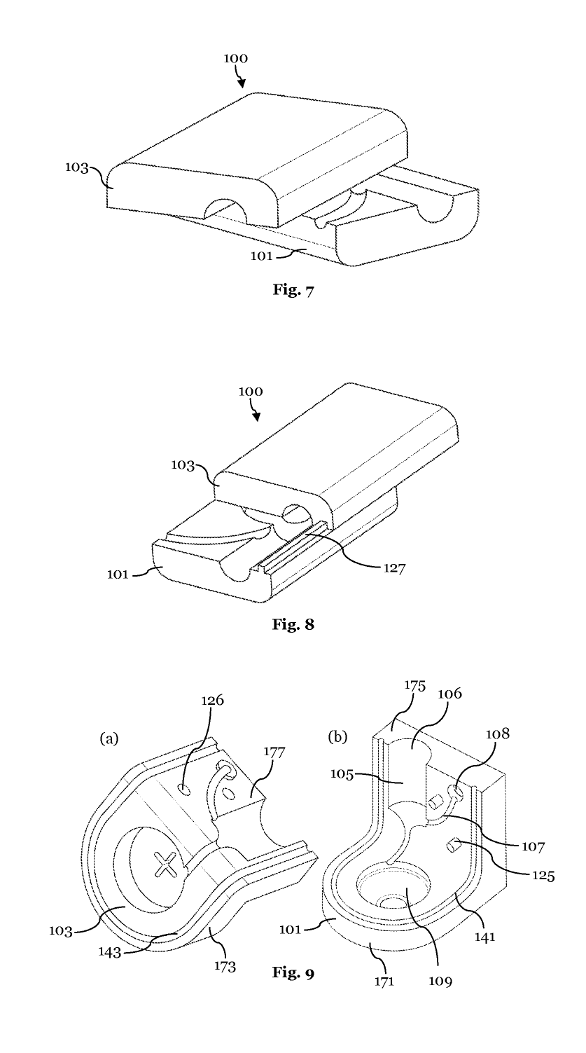

FIG. 7 a schematic view of still a further reusable frothing device;

FIG. 8 a schematic view of a further reusable frothing device;

FIG. 9 schematic views of a further example of first and second bodies;

FIG. 10 a three-dimensional view of the reusable frothing device consisting of the first and second bodies of FIG. 9;

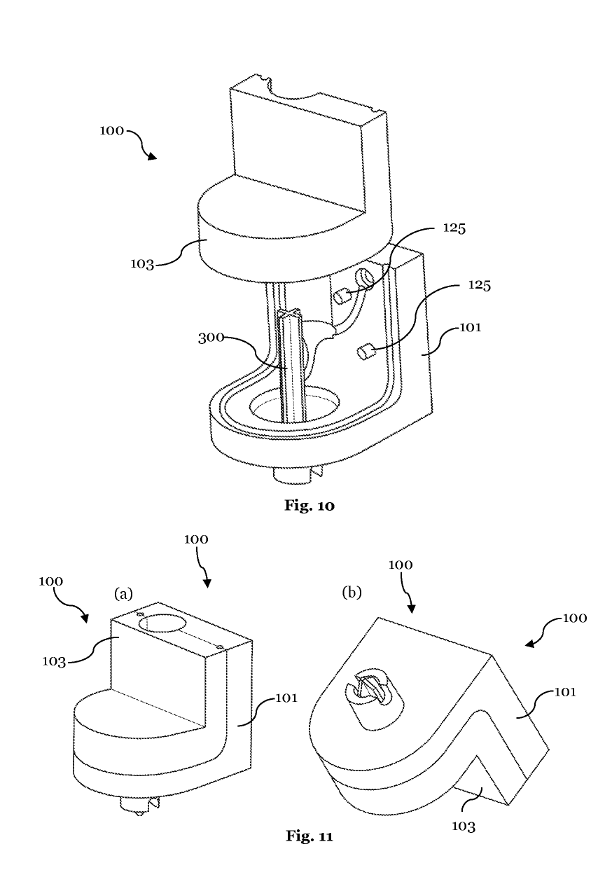

FIG. 11 views of reusable frothing devices consisting of the first and second bodies of FIG. 9;

FIG. 12 a view of a further example of a reusable frothing device;

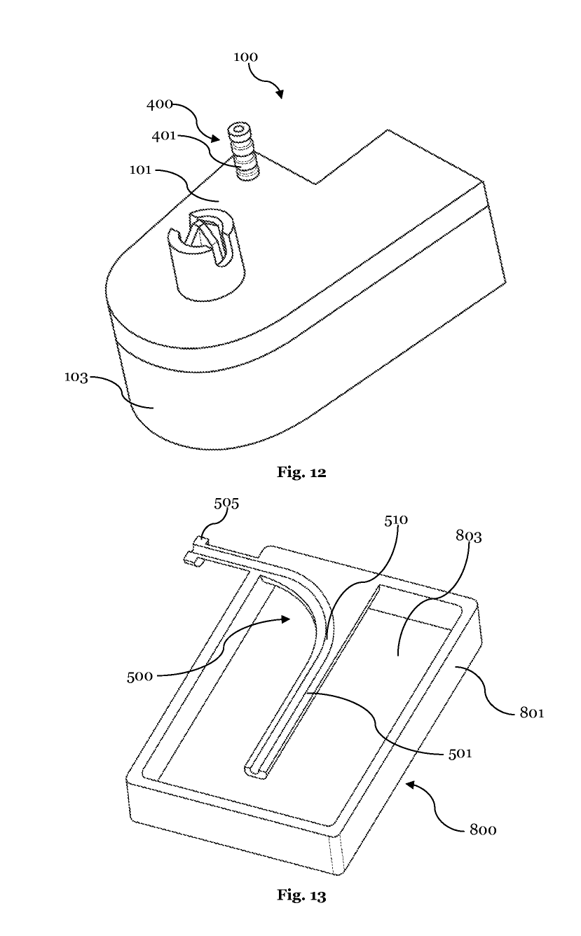

FIG. 13 a schematic view of a liquid reservoir with a supply device;

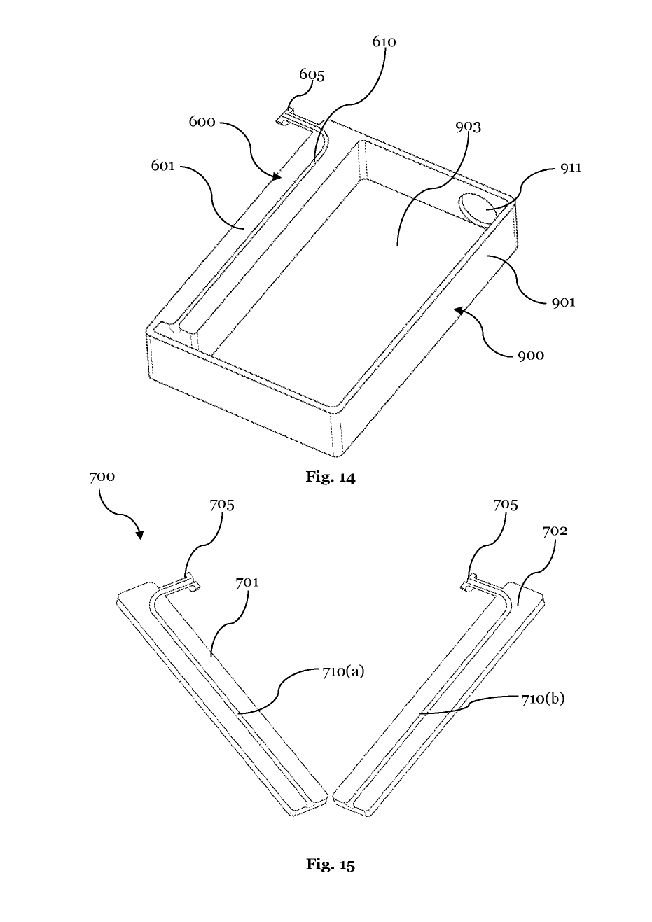

FIG. 14 a schematic view of a further embodiment of a liquid reservoir with a supply device;

FIG. 15 a further supply device; and

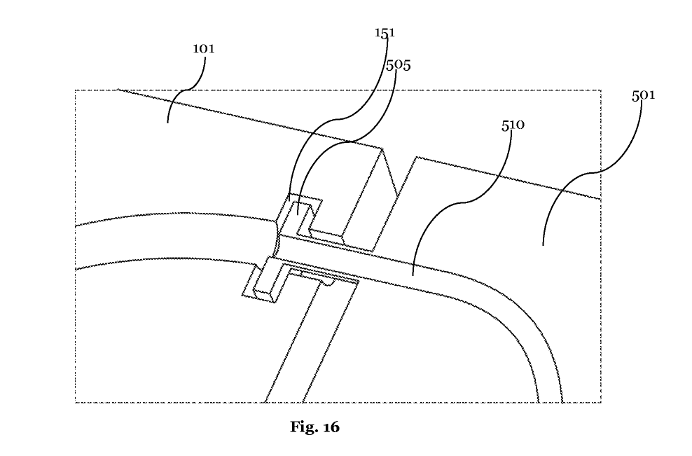

FIG. 16 the connection of a supply device to a body.

FIG. 1 shows a first body 101 with a main cavity 105 and a secondary cavity 107, which together constitute a pair 120. As it can be derived from the figure, this pair 120 is connected with an outlet port 110. The first body 101 may be connected with the further body (cf. FIGS. 4-12) in that the cavities form with corresponding surfaces of the further body or complimentary cavities in the surface of the further body complete channels. Thus, in the shown example, a main channel with a round cross-section is formed from the main cavity 105, a secondary channel with a round cross-section is formed from the secondary cavity 107 and an expansion chamber is formed from the expansion chamber cavity 109.

In the assembled state of the bodies, a fluid, like for instance hot vapor may be led through an inlet port 106 into the reusable frothing device 100 so that the resulting vapor flow in the main channel 105 generates an under-pressure in the secondary channel 107. If the secondary channel 107 is connected at its inlet port 108 to a fluid container, like for instance to a milk container, the milk is sucked in by the generated under-pressure into the main channel and is led together with the vapor into the expansion chamber 109. By the mixing with the vapor and the expansion inside the expansion chamber 109, the milk is frothed. The frothing is additionally supported by a vortex-generation inside the cylindrical expansion chamber.

In order to further abate the frothing of the fluid, in particular of the milk, it is advantageous to connect the secondary channel 107 to the main channel 105 in an appropriate angle α—which is the angle between the tangent of the secondary channel 107 at the inlet point of the secondary channel 107 into the main channel 105 with the main axis of the main channel 105. In a preferred embodiment, α is between 90° and 0°, more preferred between 60° and 10°, even more preferred between 50° and 15°, still even more preferred between 45° and 20° and mostly preferred between 40° and 25°.

In FIG. 2, a further second main channel 111 is assigned to the channel pair 120, which is constituted from the main channel 105 and the secondary channel 107, wherein the second main channel 111 leads together with the pair 120 into an expansion chamber 109. So it is possible to froth for example milk in one single component and to mix it directly with a further fluid like for instance coffee or cocoa. In FIG. 2, the expansion chamber 109 is shown in a funnel-shaped embodiment.

Such a channel group consisting of the channel pair 120 and the main channel in may be used for instance in smaller coffee- or cappuccino-makers for the home use. But it is possible to combine a plurality of such channel groups to larger arrangements. Such an arrangement, wherein two channel groups are combined, which end up together in a common expansion chamber 109 is for instance shown in FIG. 3. For instance larger beverage machines may be provided with such a combination of channel groups for the use for instance in gastronomy business. Herein, each of these channel groups may be used for the making of one kind of hot beverage, like for instance of a specific kind of coffee.

FIG. 4 shows schematic cross-sections of further possible reusable frothing devices 100, wherein for the sake of simplicity always only one channel 105 is shown in the cross-section. FIG. 4a shows a first body 101 and a second body 103 in the assembled state, wherein the bodies 101, 103 are assembled at a sectional plane 600, which is shown in the figure by a line 600. In FIG. 4b an example for a reusable frothing device 100 is shown, which consists of three bodies 101, 102 and 103. It can be gathered from this illustration that in this case the sectional plane 600 is divided up in three sectional-sub-planes 601, 603 and 605, wherein in other embodiments of the invention channels may be arranged along of each of these planes.

FIG. 4c shows a further embodiment of a reusable frothing device 100, wherein in this case a wave-shaped sectional plane 600 is shown, which is able to provide a particularly sufficient hold of the shown bodies. In spite of the shown wave-shape, also a step-shape is possible. FIG. 4d is analogous to FIG. 4a an illustration of a reusable frothing device 100, which consists of two bodies 101 and 103, wherein in this sub-figure a rectangular cross-section of the channel is shown. In general, the channels may comprise rectangular, polygonal (FIG. 4f) and oval (FIGS. 4a and 4e) cross-sections. FIG. 4e shows analogous to FIG. 4b an example with three bodies. Although in the present figures only examples are shown which consist of two bodies or of three bodies it is obvious for the person skilled in the art that also examples with four or more bodies are possible. Finally, FIG. 4f shows a further cross-section of the channel, wherein here a polygonal shape of the channel is shown. Analogous to FIG. 4c also herein an irregular cross-section of the sectional plane 600 is shown which, as already mentioned above, may support the connection of the bodies 101 and 103.

FIGS. 5a to 5d and 6 show the different examples of FIG. 4 in a three dimensional view. FIG. 5a is analogous to FIG. 4a an illustration of a reusable frothing device 100 with the plane sectional plane. Such a sectional plane may also be arranged transversely through the reusable frothing device 100, as it is shown in FIG. 5b. FIG. 5c shows an example with the separation into three parts, wherein the cleaning of the cavities is further facilitated by this splitting up. FIG. 5d shows analogous to FIG. 4d the rectangular cross-section of the main channel 105. Finally, FIG. 6 is a further three dimensional view of an example with an irregular sectional plane 600. All examples have in common that complementary cavities are provided in both bodies. I.e. each of the bodies comprises for example semi-circle-shaped cavities, which constitute in the connected state of the bodies channels with a circular cross-section. Alternatively, but less preferred, also one of the two bodies may be provided with a more or less plane surface, so that in the connected state of the bodies the complete channels comprise a semi-circle-shaped cross-section. Furthermore, all examples have in common that the cavities are all arranged in one sectional plane and thus are in the disassembled state freely accessible and thus may be cleaned in a very simple way. In other words: The bodies do not comprise any undercuts or curved channels, which are arranged in completely in the material. Thus, they are just difficult to clean.

FIG. 7 shows a further example of a reusable frothing device 100, wherein coupling means are provided, which allow that in the shown example with two parts the first body and the second body may be twisted against each other for the sake of separation. Such an embodiment is advantageous, since for example during the cleaning in a dish washer the bodies 101, 103 stay together during the cleaning process so that no single parts may be lost. As an alternative to the twisting of the shown bodies also a deviation is possible, i.e. the bodies may be for instance connected to each other at a common edge via a hinge and may be deviated around these hinge from an open state to a closed state and vice-versa.

In FIG. 8 a further example of a reusable frothing device 100 is shown, wherein in the two-part example, which is shown herein, the second body 103 comprises a rail 127 and the first body comprises a corresponding recess, i.e. here a corresponding groove (not shown), so that the first body may be slit onto the second body. Thus, this embodiment shows coupling members in the form of a tongue-and-groove-connection.

FIG. 9 shows a further example of a reusable frothing device 100, wherein in this example the first body 101 consists of first and second essentially perpendicular body halves 171, 175. Analogous to this, also the second body 103 consists of corresponding first and second body halves 173, 177, which are also arranged essentially perpendicularly to each other. At the bodies, coupling members in the form of protrusions, i.e. here bolts 125 and corresponding recesses 126, by means of which the bodies 101, 103 may be stuck together. The coupling members 125 are also arranged at the bodies. Similar coupling members may be also provided in the reusable frothing devices, which are shown in the FIGS. 1 to 6. Alternatively, or additionally to such coupling members (bolts, recesses, snap-in locks or the like) the reusable frothing device 100 may also comprise a clamping device, which connects the bodies 102, 103 with each other. Such a clamping device may be for instance a part of a coffee maker, which connects the bodies 101, 103 to each other and is provided in or at the coffee maker.

In FIG. 9 a sealing groove 141 is shown, which is able to hold a sealing cord in order to seal the reusable frothing device 100. Similar sealing grooves may be of course also provided in all embodiments according to the invention like for instance in all embodiments of the FIGS. 1 to 8.

FIG. 10 shows a three dimensional view, which shows the assembly of the reusable frothing device 100 of FIG. 9. A barb-shaped guidance member 300 with a cross-shaped cross-section is also shown. Such a guidance member 300 may be either attached to the first body 101 or at the second body 103 or maybe mounted during the assembly of the two parts at one or at both bodies. The barb-shaped guidance member 300 helps that for instance a coffee-milk-froth-mixture is guided continuously and cleanly out of the reusable frothing device 100.

As it can be seen from FIG. 10, the second body 103 may be arranged upon the first body 101 in that the bolts 125 engage in the corresponding recesses 126 (cannot be seen in this figure). In FIGS. 11a and 11b the reusable frothing device 100 of FIGS. 9 and 10 is shown in the assembled state. Contrary to the reusable frothing devices 100, which are shown in the FIGS. 1 to 8, such an embodiment with an angled sectional plane may be advantageous, if a particularly small installation size is desired.

FIG. 12 shows the assembled state of a reusable frothing device 100 consisting of a first body 101 and a second body 103, wherein a possible supply device 400 is shown in the form of a supply socket 401. Such a supply socket 401 may be used for the connection of a conventional flexible tube or a pipe with the reusable frothing device 100. Such a flexible tube or such a pipe may be connected to a liquid reservoir, in particular to a milk container so that via the supply socket 401 the corresponding liquid, in particular the milk, may be supplied to the reusable frothing device 100. The socket may be in particular realized by a beverage-straw and, thus, is a disposable part.

An advantageous further development of a possible supply device 500 is shown in FIG. 13. FIG. 13 shows a first liquid reservoir body 801 of a liquid reservoir for example for milk. This first liquid reservoir body 801 of the liquid reservoir is like the reusable frothing device 100 appropriate, to be assembled with a corresponding second liquid reservoir body (not shown) to a liquid reservoir. Herein also again coupling members like for instance bolts and corresponding recesses are possible, which also may comprise sealing members in the form of sealing grooves and o-rings. The reservoir section 803 can be seen in FIG. 13, wherein the reservoir section 803 may be for instance filled with milk.

In FIG. 13 a first supply body 501 is shown, which is an integral component of the liquid reservoir body 801. It can be gathered from the figure that, like in the above described embodiments of the reusable frothing device 100, the liquid pipe 510 is realized as a cavity in the first supply body 501. Thus also in the here shown example, the supply device 500 realizes the inventive principle, to provide liquid pipes by cavities in base bodies, so that the liquid channels are realized by the assembly of these base bodies, which may be disassembled after the use for the sake of cleaning. In particular in the case of liquids to be led like milk it is obvious that such pipes are very advantageous, since hereby in particular good hygiene conditions become possible.

An alternative supply device 600, which is realized as an integral member of a further liquid reservoir 900, is shown in FIG. 14. Similar to the above described case, a liquid pipe is realized in the form of a recess 610 in a first supply body 601. Contrary to the above shown liquid reservoir body 801, the liquid reservoir body 901 comprises an opening 911, by which the first liquid reservoir body 901 may be connected to a further liquid supply pipe. Alternatively, the opening 901 may serve for the filling-in of for instance milk into the reservoir, which is formed by the liquid reservoir body 901 and a further liquid reservoir body (not shown) without having to disassemble the reservoir.

A further alternative supply device 700 is shown in FIG. 15. The device consists of two bodies 701, 702, which are, as it can be gathered from the figures, identical, i.e. they are designed complimentarily to each other.

In this example, both bodies comprise a liquid pipe 710(a) and 710(b), respectively, which comprises in general a semi-circular-shaped cross-section. In the connected state of the two bodies 701, 702, both cavities form a circular channel. The fixation protrusion 705 is formed in a similar manner. The connection of the two bodies is realized herein again via appropriate coupling members, which allow a repeated connecting and separating, like for instance corresponding protrusions and recesses analogous to the embodiment of FIG. 9. It can be gathered from the FIGS. 13, 14 and 15 that the liquid pipes 510, 610 and 710 each comprise at one of their ends fixation members in the form of fixation protrusions 505, 605 and 705. The function of these fixation protrusions is exemplarily shown in FIG. 16 by means of the supply device 500. FIG. 16 shows a detailed view of the first body 101 and of the liquid reservoir body 801. It can be seen that the fixation protrusion 505 engage in corresponding fixation recesses 151 of the body 101. This connection may be used for instance for the connection of the supply device 500 with the inlet port 108 of the secondary channel 107. For the sealing, appropriate sealing means may be provided, like for instance o-rings.

1. Reusable frothing device for the use in a device for making beverages, comprising at least a first body and a second body, wherein at least one of the two bodies comprises cavities at a surface, wherein the cavities constitute together with a further surface of the other body in an assembled state of the reusable frothing device complete channels, wherein the channels are appropriate to guide liquids, and wherein the reusable frothing device is appropriate to be connected to supply devices by which the liquid may be let into inlets ports of the channels
characterized in that
coupling members are assigned to the bodies which allow a repeated assembling and disassembling of the bodies.

2. Reusable frothing device according to claim 1, characterized in that the coupling members are arranged at the bodies.

3. Reusable frothing device according to claim 1, characterized in that at least one of the two bodies comprises at a surface cavities and wherein the other body comprises complementary cavities so that the cavities constitute together with the complementary recesses in the assembled state of the reusable frothing device complete channels.

4. Reusable frothing device according to claim 1, characterizing that the reusable frothing device further comprises an expansion chamber, which is connected to at least one of the channels and which allows an expansion of a fluid that may be led in one of the channels.

5. Reusable frothing device according to claim 1, characterized in that at least one of the bodies comprises an expansion chamber cavity at a surface, which forms together with a further surface of the other body in the assembled state of the reusable frothing device an expansion chamber.

6. (canceled)

7. (canceled)

8. Reusable frothing device according to claim 1, characterized in that the coupling members comprise snap-lock members, which are arranged at the bodies.

9. Reusable frothing device according to claim 1, characterized in that the coupling members are designed in that the bodies are not separated completely from each other during the disassembly.

10. Reusable frothing device according to claim 1, characterized in that the coupling members are designed in that they allow a twisting or a deviating of the bodies against each other during the assembly and the disassembly of the bodies.

11. Reusable frothing device according to claim 1, characterized in that the coupling members are designed in that they allow a sliding of the bodies against each other during the assembly and the disassembly of the bodies.

12. (canceled)

13. (canceled)

14. Reusable frothing device according to claim 1, characterized in that the first body comprises a first body half and a second body half, wherein the first body half is oriented essentially perpendicularly to the second body half.

15. Reusable frothing device according to claim 1, characterized in that the reusable frothing device further comprises an outlet port for the outlet of liquids, which comprises a barb-shaped guidance member for guiding the liquids, wherein the barb-shaped guidance member preferably comprises a cross-shaped cross-section.

16. (canceled)

17. Reusable frothing device according to claim 1, characterized in that the reusable frothing device does not comprise any film.

18. Reusable frothing device according to claim 1, characterized in that the cavities from at least one pair, wherein this pair comprises a main cavity and at least one secondary cavity and wherein the secondary cavity is connected in that to the main cavity that an under-pressure is generated in the secondary cavity, if the main cavity guides fluid, in particular water vapor, so that through the secondary cavity a further fluid, in particular milk, may be sucked in into the main cavity.

19. Reusable frothing device according to claim 18, characterized in that the cavities of this pair form an angle α, wherein α is between 90° and 0°.

20. Reusable frothing device according to claim 18, characterized in that the pair of cavities is connected to an expansion chamber cavity so that the fluids are guided together into the expansion chamber cavity if the main cavity guides a fluid, in particular water vapor, and the secondary cavity guides a further fluid, in particular milk, so that an expansion of the fluids is rendered possible in order to froth at least one of the fluids, in particular the milk.

21. (canceled)

22. Reusable frothing device according to claim 1, characterized in that the reusable frothing device does not comprise any reservoir, which is filled with a liquid.

23. (canceled)

24. (canceled)

25. Supply device for the use in a device for making beverages,
characterized in that
the supply device comprises at least one first supply body and a second supply body, wherein at least one of the two supply bodies comprises at least one supply cavity at a surface, which forms together with a further surface of the other supply body in an assembled state of the supply device at least one complete channel, wherein the channel is appropriate to lead liquid, in particular milk.

26. Supply device according to claim 25, characterized in that coupling members are assigned to the supply bodies, which allow a repeated assembling and disassembling of the supply bodies.

27. (canceled)

28. (canceled)

29. (canceled)

30. (canceled)

31. The reusable frothing device of claim 1, wherein the reusable frothing device is comprised in a coffee maker.

32. The reusable frothing device of claim 1,
wherein at least one inlet port of the cavities of the reusable frothing device comprises a fixation member, which is appropriate to cooperate with a further fixation member of a supply device, wherein the supply device comprises:
at least one first supply body and a second supply body, wherein at least one of the two supply bodies comprises at least one supply cavity at a surface, which forms together with a further surface of the other supply body in an assembled state of the supply device at least one complete channel, wherein the channel is appropriate to lead liquid, in particular milk; and
wherein in the assembled state the fixation member fixes the supply device at the reusable frothing device.

33. A method, comprising:
providing a reusable frothing device, wherein the reusable frothing device comprises:
at least a first body and a second body, wherein at least one of the two bodies comprises cavities at a surface, wherein the cavities constitute together with a further surface of the other body in an assembled state of the reusable frothing device complete channels, wherein the channels are appropriate to guide liquids, and wherein the reusable frothing device is appropriate to be connected to supply devices by which the liquid may be let into inlets ports of the channels
characterized in that
coupling members are assigned to the bodies which allow a repeated assembling and disassembling of the bodies;
assembling of the bodies to the reusable frothing device;
inserting the reusable frothing device in a device for making beverages;
making a beverage or several beverages in one or more cycles by the use of the reusable frothing device;
removing the reusable frothing device from the device for making beverages;
disassembling of the bodies; and
cleaning of the bodies.

34. A reusable liquid frothing device, comprising:
a first input, configured to couple to a vapor supply;
a second input, configured to couple to a liquid supply;
an output; and
at least two parts, comprising respective surfaces, wherein the at least two parts are configured to mate at the respective surfaces when assembled;
wherein when mated the at least two parts form:
an expansion chamber, connected to the output;
a first channel, connecting the first input to the expansion chamber; and
a second channel, connecting the second input to the first channel;
wherein the first channel is configured to convey vapor from the first input to the expansion chamber;
wherein the second channel is configured to convey liquid from the second input to the first channel, thereby generating a mixture of the liquid and the vapor;
wherein the expansion chamber is configured to froth the mixture of the liquid and the vapor, and provide the frothed mixture to the output; and
wherein the at least two parts are configured to be disassembled by a user for cleaning

35. The reusable liquid frothing device of claim 31, further comprising:
at least one coupling member, wherein the at least one coupling member is comprised in or configured to couple to at least one part of the at least two parts, and wherein the at least one coupling member is configured to mate the at least two parts.

36. The reusable liquid frothing device of claim 32, wherein the coupling member comprises:
at least one locking mechanism, coupled to or comprised in the at least one coupling member, wherein the at least one locking mechanism is configured to lock the at least two parts after mating.

37. The reusable liquid frothing device of claim 32, wherein the at least one coupling member is configured to allow assembly and disassembly of the at least two parts via a rotation of at least one part of the at least two parts with respect to another part of the at least two parts.

38. The reusable liquid frothing device of claim 32, wherein the at least one coupling member is configured to allow assembly and disassembly of the at least two parts via a linear sliding of at least one part of the at least two parts with respect to another part of the at least two parts.
